(19) United States
(12) Patent Application Publication
(10) Pub. No.: US 2026/0178057 A1
(43) Pub. Date: Jun. 25, 2026

(54) COOPERATIVE POSITIONING METHOD, COOPERATIVE POSITIONING DEVICE, ELECTRONIC DEVICE, AND COMPUTER PROGRAM PRODUCT

(71) Applicant: UBTECH ROBOTICS CORP LTD, Shenzhen (CN)

(72) Inventors: Chuangpeng Guo, Shenzhen (CN); Jinbing Xiong, Shenzhen (CN); Xin Fu, Shenzhen (CN); Junbin Xu, Shenzhen (CN); Haoping Zheng, Shenzhen (CN)

(21) Appl. No.: 19/419,182

(22) Filed: Dec. 15, 2025

(30) Foreign Application Priority Data
Dec. 20, 2024 (CN) 202411904187.8

(51) Int. Cl. G05D 1/69; G05D 1/644

(52) U.S. Cl. CPC G05D 1/69; G05D 1/644

(57) ABSTRACT

A cooperative positioning method, a cooperative positioning device, an electronic device, and a computer program product are provided. In the cooperative positioning method, a first electronic device is able to accurately determine a pose deviation based on a first pose of the first robot in a local coordinate system of the first robot, second poses of second electronic devices, and first distances between the first electronic device and the second electronic devices. The first pose of the first electronic device is allowed to be optimized based on the pose deviation, thereby obtaining a target pose of the first electronic device. In other words, the first electronic device is able to accurately determine a pose in the global coordinate system without any external device, thereby improving accuracy and stability of positioning of the first electronic device.

### CROSS-REFERENCE TO RELATED APPLICATION

The present disclosure claims foreign priority to Chinese Patent Application No. CN202411904187.8, titled “COOPERATIVE POSITIONING METHOD, COOPERATIVE POSITIONING DEVICE, ELECTRONIC DEVICE, AND COMPUTER PROGRAM PRODUCT”, filed on Dec. 20, 2024 in China National Intellectual Property Administration, and the entire contents of which is hereby incorporated by reference.

### TECHNICAL FIELD

The present disclosure relates to a technical field of robots, and in particular to a cooperative positioning method, a cooperative positioning device, an electronic device, and a computer program product.

### BACKGROUND

Currently, multi-robot systems are widely used in many fields, such as service industry, hazardous environment exploration, disaster site search and rescue, and formation flying. A multi-robot system is able to accomplish tasks through cooperation of robots. When the multi-robot system completes a task through the robots, it is necessary to accurately determine poses of all robots within the multi-robot system. With development of simultaneous positioning and mapping (SLAM) technology, each of the robots is positioned by multi-sensor fusion technology (such as visual inertial odometry and lidar odometry), and positioning information of a single robot is transmitted to other robots in the multi-robot system through networking, so that the robots cooperate with each other to complete the task. However, positioning errors of the single robot increase over time, which is particularly severe in the multi-robot system. Due to accumulated positioning errors of the robots, positioning accuracy of the robots is poor, which easily leads to task failure of the multi-robot system.

### SUMMARY

Embodiments of the present disclosure provide a cooperative positioning method, a cooperative positioning device, an electronic device, and a computer program product, which improve positioning accuracy of robots in a multi-robot system and reduce a possibility of task failure in the multi-robot system.

In a first aspect, the present disclosure provides a cooperative positioning method applied to a first electronic device. The cooperative positioning method comprises steps:
obtaining a first pose, second poses, and first distances, where the first pose is a pose of the first electronic device in a local coordinate system of the first electronic device at a first moment, the second poses are poses of second electronic devices at the first moment, and each of the first distances is a distance between the first electronic device and a corresponding second electronic device at the first moment;
determining a pose deviation of the first electronic device according to the first pose, the second poses, and the first distances; and
optimizing the first pose according to the pose deviation to obtain a target pose of the first electronic device.

In the cooperative positioning method, the first electronic device is able to accurately determine the pose deviation based on the first pose in the local coordinate system, the second poses of the second electronic devices, and the first distances between the first electronic device and the second electronic devices. Therefore, the first pose of the first electronic device is allowed to be optimized based on the pose deviation, thereby obtaining the target pose of the first electronic device. In other words, the first electronic device is able to accurately determine a pose in the global coordinate system without any external device, thereby improving accuracy and stability of positioning of the first electronic device.

In some embodiments, the step of determining the pose deviation of the first electronic device according to the first pose, the second poses, and the first distances comprises steps:
determining a first initial pose of the first electronic device according to the second poses and the first distances; and
determining the pose deviation of the first electronic device according to the first initial pose and the first pose.

In other embodiments, the cooperative positioning method further comprises a step:
obtaining third poses, fourth poses, second distances, a first displacement, and second displacements.

The third poses are poses of the first electronic device in the local coordinate system of the first electronic device at second moments. The fourth poses are poses of the second electronic devices at the second moments. The second distances are distances between the first electronic device and the second electronic devices at the second moments. The first displacement is a displacement of the first electronic device at the first moment. The second displacements are displacements of the first electronic device at the second moments. The second moments are earlier than the first moment.

The step of determining the pose deviation of the first electronic device according to the first pose, the second poses, and the first distances comprises a step:
determining the pose deviation of the first electronic device according to the first pose, the second poses, the third poses, the fourth poses, the first distances, the second distances, the first displacement, and the second displacements.

In one embodiment, the step of determining the pose deviation of the first electronic device according to the first pose, the second poses, the third poses, the fourth poses, the first distances, the second distances, the first displacement, and the second displacements comprises steps:
determining the first initial pose and a second initial poses of the first electronic device according to the second poses, the fourth poses, the first distances, the second distances, the first displacement, and the second displacements; and
determining the pose deviation of the first electronic device according to the first initial pose, the second initial poses, the first pose, and the third poses.

Optionally, the step of determining the first initial pose and the second initial poses of the first electronic device according to the second poses, the fourth poses, the first distances, the second distances, the first displacement, and the second displacements comprises:
obtaining the first initial pose and the second initial poses of the first electronic device by minimizing a first optimization objective.

The first optimization objective is represented by:

$$min {\sum }_{k = 1}^{m} {\sum }_{w = 1}^{n} {( {‖ {\hat{p}}_{( S - w )} - {φ}_{( S - w )} - {p}_{k} ( w ) ‖}^{2} - {d}_{( {S}_{k} - w , w )}^{2} )}^{2} .$$

m is the number of the second electronic devices. n is the number of the second moments where the second poses or the fourth poses are obtained. \hat{p}_{(S-w)} represents the first initial pose or a second initial pose of the first electronic device at a moment w. φ_{(S-s)} represents the first displacement or a second displacement of the first electronic device at the moment w. pₖ^{(w)} represents a second pose or a fourth pose of a k-th second electronic device at the moment w. d₍₈_{ₖ}_{-w,w)} represents a first distance or a second distance between the first electronic device and the k-th second electronic device at the moment w.

Optionally, the step of determining the pose deviation of the first electronic device according to the first initial pose, the second initial poses, the first pose, and the third poses comprises
obtaining the pose deviation of the first electronic device by minimizing a second optimization objective.

The pose deviation of the first electronic device comprises a rotation deviation and a translation deviation. The second optimization objective is:

$$min {\sum }_{w = 1}^{n} {( Δ \hat{R} {p}_{( S - w )} - Δ \hat{φ} - {\hat{p}}_{( S - w )} )}^{2} .$$

n is the number of the second moments where the second poses or the fourth poses are obtained. Δ\hat{R} represents the rotation deviation. \hat{p}_{(S-w)} represents the translation deviation. p_{(S-W)} is the first pose or a third pose of the first electronic device at a moment w. \hat{p}_{(S-w)} is the first initial pose or a second initial pose of the first electronic device at the moment w.

Optionally, the step of determining the pose deviation of the first electronic device according to the first pose, the second poses, the third poses, the fourth poses, the first distances, the second distances, the first displacement, and the second displacements comprises a step of obtaining the pose deviation of the first electronic device by minimizing a third optimization objective.

The pose deviation of the first electronic device comprises a rotation deviation and a translation deviation. The third optimization objective is:

$$min {\sum }_{k = 1}^{m} {\sum }_{w = 1}^{n} {( {‖ \hat{R} {p}_{( S - w )} - Δ \hat{φ} - \hat{R} {φ}_{( s - w )} - {p}_{k} ( w ) ‖}^{2} - {d}_{( {S}_{k} - w , w )}^{2} )}^{2} .$$

m is the number of the second electronic devices. n is the number of the second moments where the second poses or the fourth poses are obtained. \hat{R} is a rotation matrix. Δ\hat{φ} is the translation deviation. p_{(S-w)} represents the first pose or a third pose of the first electronic device at a moment w. p_{(S-w)} represents the first displacement or a second displacement of the first electronic device at the moment w. pₖ^{(w)} represents a second pose or a fourth pose of a k-th second electronic device at the moment w. d₍ₛ_{ₖ}_{-w,w)} represents a first distance or a second distance between the first electronic device and the k-th second electronic device at the moment w.

In some embodiments, the first electronic device comprises a first ultra-wideband (UWB) module. The second electronic devices comprise second UWB modules. The step of obtaining the first pose, the second poses, and the first distances comprises steps:
obtaining the second poses broadcast by the second UWB modules through the first UWB module; and
obtaining the first distances through the first UWB module.

In a second aspect, the present disclosure provides the cooperative positioning device applied to a first electronic device. The cooperative positioning device comprises a data acquisition module, a pose deviation acquisition module, and a pose optimization module.

The data acquisition module is configured to obtain a first pose, second poses, and first distances. The first pose is a pose of the first electronic device in a local coordinate system of the first electronic device at a first moment. The second poses are poses of second electronic devices at the first moment. Each of the first distances is a distance between the first electronic device and a corresponding second electronic device at the first moment. The pose deviation acquisition module is configured to determine a pose deviation of the first electronic device according to the first pose, the second poses, and the first distances. The pose optimization module is configured to optimize the first pose according to the pose deviation to obtain a target pose of the first electronic device.

In a third aspect, the present disclosure provides the electronic device. The electronic device comprises a memory, a processor, and a computer program stored in the memory and executable on the processor. When the processor executes the computer program, the electronic device implements the cooperative positioning method described above.

In a fourth aspect, the present disclosure provides a computer-readable storage medium. The computer-readable storage medium comprises a computer program stored thereon. When executed by a computer, the computer program causes a computer to perform the cooperative positioning method described above.

In a fifth aspect, the present disclosure provides a computer program product. The computer program product comprises a computer program. When the computer program is executed by an electronic device, the computer program causes the electronic device to implement the cooperative positioning method described above.

It is understood that technical effects of the second aspect to the fifth aspect may refer to related description of the cooperative positioning method of the first aspect.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a flow chart of a cooperative positioning method according to one embodiment of the present disclosure.

FIG. 2 is another flow chart of the cooperative positioning method according to one embodiment of the present disclosure.

FIG. 3 is a block diagram of a cooperative positioning device according to one embodiment of the present disclosure.

FIG. 4 is a block diagram of an electronic device according to one embodiment of the present disclosure.

### DETAILED DESCRIPTION

The following descriptions are provided for purposes of explanation and cannot be regarded as limitations. Specific details such as specific system structures and technologies are proposed to provide a thorough understanding of the embodiments of the present disclosure. However, it is apparent to those skilled in the art that the present disclosure may be practiced in other embodiments without these specific details. In other instances, detailed descriptions of well-known systems, devices, circuits, and methods are omitted so as not to obscure the description of the present disclosure with unnecessary detail.

It should be understood that when used in the specification and the appended claims of the present invention, the term “comprise” indicates a presence of described features, integers, steps, operations, elements, and/or components, but does not preclude a presence or addition of one or more other features, integers, steps, operations, elements, components, and/or sets thereof.

It should also be understood that the term “and/or” used in the specification and the appended claims of the present disclosure refers to any combination of one or more of the associated listed items and all possible combinations.

As used in the specification of the present disclosure and the appended claims, the term “if” can be interpreted as “when . . . ”, “once”, “in response to determining . . . ”, or “in response to monitoring” depending on the context. Similarly, the phrase “if it is determined or “if [described condition or event] is monitored” can be interpreted as meaning “once it is determined”, “in response to determination”, “once [described condition or event] is monitored”, or “in response to monitoring [described condition or event]” depending on the context thereof.

In addition, in the description of the specification and the appended claims of the present disclosure, the terms “first”, “second”, “third”, etc., are only used for distinguishing descriptions, and cannot be understood as indicating or implying relative importance.

Reference throughout this specification to “one embodiment” or “some embodiments” or the like means that a particular feature, structure, or characteristic described in connection with the embodiment is comprised in one or more embodiments of the present disclosure. Thus, appearances of phrases “in one embodiment”, “in some embodiments”, “in some other embodiments”, “in other embodiments”, and the like in various places throughout the specification are not necessarily all referring to the same embodiment, but mean “one or more but not all embodiments” unless otherwise specifically emphasized in other ways. The terms “comprising”, “comprise” “have” and variations thereof mean “including, but not limited to”, unless otherwise specifically emphasized.

Multi-robot systems are widely used in many fields, such as service industry, hazardous environment exploration, disaster site search and rescue, and formation flying. The multi-robot systems are able to accomplish tasks through a cooperation of robots. Compared to a single robot performing various tasks, coordinating a group of autonomous robots to perform a common task has many advantages, such as greater scalability, flexibility, and adaptability. When the multi-robot systems completes the tasks through the robots, it is necessary to accurately determine poses of all robots within the multi-robot systems.

In multi-robot systems, a common positioning method is to establish a communication network. In the communication network, each of the robots knows its global pose in the communication network and broadcasts the global pose to other robots. Typically, in a multi-robot system, each of the robots determines the global pose through an external positioning method. For example, a global positioning system (GPS) is adopted to determine the global pose of each of the robots in the multi-robot system, while the external positioning method offers high accuracy in indoor environments, the external positioning method requires to deploy a bulky base station in advance and involves tedious and challenging deployment work.

Furthermore, the external positioning method relies on the GPS and a known environment, which is not suitable to be executed in GPS-limited environments (such as the field), and limits flexibility of the multi-robot system in certain scenarios (e.g., field search and swarm formation). Additionally, if the base station is interfered with or damaged, the entire multi-robot system may malfunction.

With development of simultaneous positioning and mapping (SLAM) technology, a single robot is positioned by multi-sensor fusion technology (such as visual inertial odometry and lidar odometry), and positioning information of a single robot is transmitted to other robots in the multi-robot system through networking, so that the robots cooperate with each other to complete the tasks. The SLAM technology is able to perform positioning without support of external devices and make full use of the positioning information of each of the robots to improve positioning accuracy and robustness of the multi-robot system. However, positioning errors of the single robot increase over time. For example, during prolonged movement, a coordinate system of a SLAM system of the single robot may deviate from initial coordinates and orientation, leading to an accumulation of pose errors. The problem is particularly severe in the multi-robot system. For instance, if two robots move linearly, assuming their respective SLAM systems do not interfere with each other, the two robots may move toward each other or move away from each other. That is, in the multi-robot system, due to the accumulated errors of each of the robots, a risk of collision of the robots increases when the robots are out of each other's line of sight, leading to mission failure. Therefore, improving the accuracy of robot positioning under GPS-limited environments is a pressing issue that needs to be addressed in the field.

To solve the problems, embodiments of the present disclosure provide a cooperative positioning method, a cooperative positioning device, an electronic device, and a computer program product. In the cooperative positioning method, a first electronic device is configured to obtain a first pose, second poses, and first distances. The first pose is a pose of the first electronic device in a local coordinate system of the first electronic device at a first moment. The second poses are poses of second electronic devices at the first moment. Each of the first distances is a distance between the first electronic device and a corresponding second electronic device at the first moment. Then, the first electronic device is configured to determine a pose deviation of the first electronic device according to the first pose, the second poses, and the first distances. The first electronic device is further configured to optimize the first pose according to the pose deviation to obtain a target pose of the first electronic device.

That is, in the cooperative positioning method, the first electronic device is able to accurately determine the pose deviation based on the first pose in the local coordinate system, the second poses of the second electronic devices, and the first distances between the first electronic device and the second electronic devices. Therefore, the first pose of the first electronic device is allowed to be optimized based on the pose deviation, thereby obtaining the target pose of the first electronic device. In other words, the first electronic device is able to accurately determine a pose in the global coordinate system without any external device, thereby improving accuracy and stability of positioning of the first electronic device. The cooperative positioning method is highly user-friendly and practical.

In the embodiment, the first electronic device and the second electronic devices are electronic devices in the same distributed system, such as electronic devices in a distributed system where multiple electronic devices collaborate on a task. The first electronic device and the second electronic devices may be electronic devices capable of positioning and movement, such as robots, unmanned vehicles, drones, or unmanned boats, which are not limited thereto. The following embodiments take an example that the first electronic device and the second electronic devices are robots in a multi-robot system for further illustration.

The collaborative positioning method of the present disclosure is described in detail below with reference to the accompanying drawings and specific application scenarios.

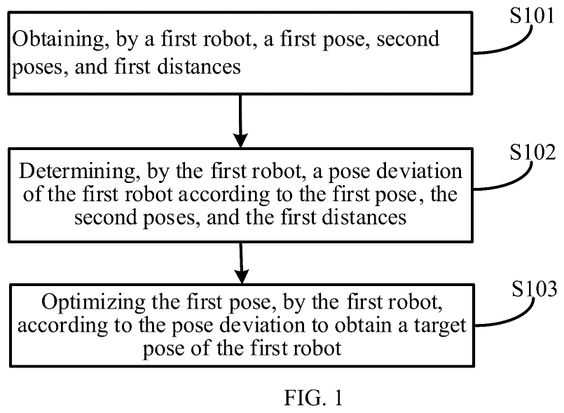

FIG. 1 is a flow chart of the cooperative positioning method according to one embodiment of the present disclosure. The cooperative positioning method is allowed to be applied to any one of the robots in the multi-robot system (a first robot is taken as an example below). As shown in FIG. 1, the cooperative positioning method comprises steps S101-S103.

The step S101 comprises obtaining, by a first robot, a first pose, second poses, and first distances.

It should be noted that the first pose is a pose of the first robot in a local coordinate system of the first robot at a first moment. The second poses are poses of second robots at the first moment. Each of the first distances is a distance between the first robot and a corresponding second robot at the first moment. The first moment may be any moment. Each of the second poses of the second robots is a pose of a corresponding second robot in a local coordinate system thereof, or each of the second poses is the pose of the corresponding second robots in a global coordinate system. Each local coordinate system is a coordinate system defined by each of the robots itself. The global coordinate system is a coordinate system shared by all of the robots in the multi-robot system.

For example, for a specific second robot (e.g., a second robot A), without pose optimization, a second pose of the second robot A is a pose in a local coordinate system of the second robot A. After pose optimization, the second pose of the second robot A is a target pose of the second robot A in the global coordinate system. The pose optimization refers to a process of obtaining a target pose of each of the robots through the cooperative positioning method described in the embodiment.

In some embodiments, each of the robots in the multi-robot system has a single-robot positioning function. For instance, each of the robots in the multi-robot system is positioned through visual SLAM, laser SLAM, or visual inertial odometry (VIO) to obtain a corresponding pose in the corresponding local coordinate system.

In other embodiments, each of the robots in the multi-robot system has an ultra-wideband (UWB) ranging function. For instance, each of the robots comprises a UWB module. Taking the first robot as an example, the first robot is able to obtain the first distances between the first robot and the second robots within a UWB signal range of the UWB module thereof. After obtaining the first pose of the first robot in the local coordinate system at the first moment by visual SLAM, laser SLAM, or VIO, the first robot in the multi-robot system writes the first pose into the UWB module thereof and broadcasts the first pose externally, enabling the second robots to obtain the first pose of the first robot based on broadcast information. Each UWB module utilizes UWB signals for data transmission, which has high precision and strong anti-interference capabilities. In the embodiment, the UWB module of the first robot is able to obtain the first distances between the first robot and the second robots and obtain the second poses of the second robots. The pose deviation of the first robot is determined based on the first distances and the second poses of the second robots to optimize the first pose of the first robot. The collaborative positioning method involves small amounts of interactive data, enabling lightweight data communication, lower performance requirements for the first robot, and allowing the robots to achieve high-precision positioning in indoor and complex environments.

In the embodiment, the first robot is able to obtain the first pose in the local coordinate system thereof at the first moment by visual SLAM, laser SLAM, or VIO. Each of the second robots is also able to obtain a corresponding second pose in the local coordinate system thereof by visual SLAM, laser SLAM, or VIO, and each of the second robots is further able to broadcast the corresponding second pose to the outside through the UWB module thereof. The first robot is able to obtain each of the second poses broadcast by the UWB module of each of the second robots. Furthermore, the first robot is further able to measure distances (i.e., the first distances) between the first robot and the second robots through the UWB module thereof.

It should be noted that the embodiment of the present disclosure does not limit a method by which the first robot measures the first distances between the first robot and the second robots via the UWB module of the first robot, and the first distances between the first robot and the second robots may be measured according to prior methods.

In one embodiment, each of the robots in the multi-robot system is able to obtain the distances between itself and the other robots, and obtain the poses of the other robots, at a predetermined time interval. That is, the first robot is able to obtain the first distances between the first robot and the second robots, and obtain the poses of the second robots, at the predetermined time interval. The predetermined time interval of the first robot may be the same or be different from the present time interval of any one of the second robots, which is determined according to the actual scenario. Furthermore, the predetermined time interval of each of the robots may also be determined according to the actual scenario, which is not limited thereto.

The step S102 comprises determining, by the first robot, a pose deviation of the first robot according to the first pose, the second poses, and the first distances.

It should be understood that pose deviation of the first robot comprises a rotation deviation (^{Δyaw}) and a translation deviation (^{Δx, Δy, Δz}).

In the embodiment, the pose deviation is determined by the first pose, the second poses, and the first distances, which allows the first pose of the first robot to be optimized based on the pose deviation, rather than direct pose optimization. In this way, an impact of pose jumps on pose optimization reduces and accuracy and stability of pose optimization of the first robot improves.

In some embodiments, when the number of the second robots whose second poses are obtained by the first robot is not less than a predetermined number (e.g., the predetermined number A), that is, when the first robot obtains a sufficient number of first distances and the second poses corresponding to the second robots, the first robot is able to directly determine the pose deviation thereof based on the first pose, the second poses, and the first distances at the first moment. It should be understood that the predetermined number A is specifically determined according to the actual scenario, which is not limited thereto.

Optionally, the first robot is able to determine the first initial pose based on the second poses of the second robots at the first moment and the first distances between the first robot and the second robots. That is, the target pose of the first robot in the global coordinate system at the first moment is able to be estimated based on the second poses of the second robots at the first moment and each of the first distances between the first robot and the corresponding second robot. Subsequently, the first robot is able to determine the pose deviation based on the first initial pose and the first pose at the first moment. Therefore, the pose of the first robot is in the global coordinate system at the first moment is optimized based on the pose deviation. In other words, the first initial pose of the first robot is an estimated pose of the first robot in the global coordinate system at the first moment.

In one embodiment, the first robot is able to estimate the first initial pose through a least-squares optimization method. For example, the first initial pose of the first robot is estimated by constructing a residual function through a nonlinear optimization library such as CERES or G20.

In one optional embodiment, the first robot is able to estimate the first initial pose by minimizing a sum of squared ranging errors, based on the first distances between the first robot and the second robots and the second poses of the second robots.

For instance, the first robot is able to obtain the first initial pose by minimizing a specific optimization objective (e.g., an optimization objective A). The optimization objective A is represented by:

$$min {\sum }_{k = 1}^{m} {( {‖ {\hat{p}}_{S} - {p}_{k} ‖}^{2} - {d}_{{S}_{k}}^{2} )}^{2} .$$

m is the number of the second robots. \hat{p}_{S} represents the first initial pose of the first robot at the first moment. pₖ represents a second pose of a k-th second robot at the first moment. d_{S}_{ₖ} represents a first distance between the first robot and the k-th second robot at the first moment. It should be understood that the number m of the second robots at the first moment refers to the number of second robots for which the first robot is able to obtain the second poses.

For instance, when minimizing the optimization objective A, when it is the first time to optimize the pose of the first robot, an initial value of \hat{p}_{S} is determined as 0. When it is not the first time that the first robot is optimized for the target pose, that is, the first robot has been optimized for the target pose before, in order to reduce the number of iterations and ensure stability of a solution, the target pose of the first robot obtained from a last pose optimization is configured as the initial value of \hat{p}_{S}.

In one optional embodiment, after determining the first initial pose of the first robot, the first robot determines the pose deviation of the first robot based on the first initial pose and the first pose. For example, the first robot obtains the pose deviation of the first robot by minimizing another specific optimization objective (e.g. an optimization objective B). The optimization objective B is represented by:

$${min ( Δ \hat{R} {p}_{s} + Δ \hat{φ} - {\hat{p}}_{S} )}^{2} .$$

Δ\hat{R} is the rotation deviation. Δ\hat{φ} (is the translation deviation. p_{S} is the first pose of the first robot at the first moment. \hat{p}_{S} is the first initial pose of the first robot at the first moment.

In other embodiments, when the number of the robots is limited, for example, when the number of the second robots that the first robot is able to obtain the second poses is less than a predetermined number (e.g., a predetermined number B), historical data of the robots (such as a historical trajectory of the first robot, historical distances between the first robot and the second robots, and historical trajectories of the second robots) is used based on an extended sliding windows to determine the pose deviation of the first robot, so as to solve a problem of multiple solutions and no solutions in distributed positioning, thereby meeting real-time and stability requirements. That is, a limitation of the number of the robots is allowed to be compensated for by a relative movement of the extended sliding windows, so that a cooperative positioning effect is achieved between two robots. The predetermined number B is specifically determined according to the actual scenario, which is not limited thereto.

In other words, when the number of robots is limited, the first robot determines the pose deviation of the first robot based on the pose of the first robot, the poses of the second robots, the distances between the first robot and the second robots, and a displacement of the first robot when there is relative movement between the first robot and the second robots. That is, the first moment is a moment when there is relative movement between the first robot and the second robots. Second moments described below are also moments when there is relative movement between the first robot and the second robot.

In one embodiment, the first robot is further configured to obtain third poses, fourth poses, second distances, a first displacement, and second displacements, and the first robot is further configured to determine the pose deviation of the first robot according to the first pose, the second poses, the third poses, the fourth poses, the first distances, the second distances, the first displacement, and the second displacements. The third poses are poses of the first robot in the local coordinate system of the first robot at second moments. The fourth poses are poses of the second robots at the second moments. The second distances are distances between the first robot and the second robots at the second moments. The first displacement is a displacement of the first robot at the first moment. The second displacements are displacements of the first robot at the second moments. The second moments are earlier than the first moment.

It should be noted that the number of the second robots is not less than 1. The second moments are earlier than the first moment. The number of the second moments of each of the second robots is determined according to a size of a corresponding sliding window. The size of each of the sliding windows is determined according to the actual scenario, which is not limited thereto. For example, the size of each of the sliding windows is determined to be any value such as 5, 6, or 8 according to the actual scenario.

It should be understood that at a current moment, the displacement of the first robot may refer to a displacement of the first robot during a period from a previous moment to the current moment. For example, when the first moment is a moment T5 and the second moments comprise a moment T1, a moment T2, a moment T3 and a moment T4. The moment T1 is earlier than the moment T2. The moment T2 is earlier than the moment T3. The moment T3 is earlier than the moment T4. The moment T4 is earlier than the moment T5. At the first moment (such as the moment T5), the displacement of the first robot refers to the displacement of the first robot during the period from the moment T4 to the moment T5. At a specific moment of the second moments (such as the moment T3), the displacement of the first robot at the moment T3 refers to the displacement of the first robot during the period from the moment T2 to the moment T3.

As can be seen from the foregoing, the first robot is configured to obtain the distances between the first robot and the second robots at the predetermined time interval thereof, and the first robot is further configured to obtain the poses of the second robots. Assume that at the moment T1, the first robot obtains a distance between the first robot and the robot B (e.g., a distance B1), a pose of the robot B (e.g., a pose B1), a distance between the first robot and a robot C (e.g., a distance C1), a pose of the robot C (e.g., a pose C1), a distance between the first robot and a robot D (e.g., a distance D1), and a pose of the robot D (e.g., a pose D1), and so on.

Subsequently, the first robot determines whether there is relative movement between the first robot and the robot B at the moment T1 based on the pose of the first robot and the pose B1 of the robot B at the moment T1, and the pose of the first robot and the pose of the robot B at a moment before the moment T1. When it is determined that there is relative movement between the first robot and the robot B at the moment T1, the first robot Timestamp synchronization of the distance B1 and the pose B1, and then writes the distance B1 and the pose B1 into a sliding window corresponding to the robot B in the first robot.

Similarly, the first robot determines whether there is relative movement between the first robot and the robot C at the moment T1. When it is determined that there is relative movement between the first robot and the robot C at the moment T1, the first robot synchronizes timestamps of the distance C1 and the pose C1, and then writes the distance C1 and the pose C1 into a sliding window corresponding to the robot C in the first robot. The first robot further determines whether there is relative movement between the first robot and the robot D at the moment T1. When it is determined that there is relative movement between the first robot and the robot D at the moment T1, the first robot synchronizes timestamps of the distance D1 and the pose D1, and writes the distance D1 and the pose D1 into a sliding window corresponding to the robot D in the first robot, etc.

Assume that at the moment T2, the first robot obtains the distance between the first robot and the robot B (for example, a distance B2), the pose of the robot B (e.g., a pose B2), the distance between the first robot and the robot C (e.g., a, distance C2), the pose of the robot C (e.g., a pose C2), the distance between the first robot and the robot D (e.g., a distance D2), and the pose of the robot D (e.g., a pose D2), etc.

Subsequently, the first robot respectively determines whether there is relative movement between the first robot and the robot B, whether there is relative movement between the first robot and the robot C, and whether there is relative movement between the first robot and the robot D at the moment T2, etc. When it is determined that there is relative movement between the first robot and the robot B, the first robot synchronizes timestamps of the distance B2 and the pose B2, and then writes the distance B2 and the pose B2 into the sliding window corresponding to the robot B in the first robot. When it is determined that there is relative movement between the first robot and robot C, the first robot synchronizes timestamps of the distance C2 and the pose C2, and then writes the distance C2 and the pose C2, into the sliding window corresponding to the robot C in the first robot. Similarly, when it is determined that there is relative movement between the first robot and the robot D, the first robot synchronizes timestamps of the distance D2 and the pose D2, and writes the distance D2 and the pose D2 into the sliding window corresponding to the robot D in the first robot, etc.

When the size of one of the sliding windows in the first robot meets a size requirement, the first robot is triggered to determine the pose deviation. For example, when the size of one of the sliding windows is 5, that is, when the one of the sliding windows in the first robot comprises data of five moments (i.e., poses and distances at the five moments), the first robot is triggered to determine the pose deviation, so as to optimize the pose deviation corresponding to the first robot and improve the accuracy of the pose of the first robot.

In one optional embodiment, the first robot is configured to determine the first initial pose and second initial poses of the first robot according to the second poses, the fourth poses, the first distances, the second distances, the first displacement, and the second displacements. The first robot is further configured to determine the pose deviation of the first robot according to the first initial pose, the second initial pose, the first pose, and the third poses. The first initial pose is a pose estimated by the first robot in the global coordinate system at the first moment. The second initial poses are poses estimated by the first robot in the global coordinate system at the second moments.

In one embodiment, the first robot estimates the first initial pose and the second initial poses of the first robot by using the least squares optimization method. Specifically, the first robot obtains the first initial pose and the second initial poses of the first robot by minimizing a specific optimization objective (such as a first optimization objective). The first optimization objective is represented by:

$$min {\sum }_{k = 1}^{m} {\sum }_{w = 1}^{n} {( {‖ {\hat{p}}_{( S - w )} - {φ}_{( S - w )} - {p}_{k} ( w ) ‖}^{2} - {d}_{( {S}_{k} - w , w )}^{2} )}^{2} .$$

m is the number of the second robots. n is the number of the second moments where the second poses or the fourth poses are obtained. \hat{p}_{(S-w)} represents the first initial pose or the second initial poses of the first robot at a moment w. φ_{(S-w)} represents the first displacement or a second displacement of the first robot at the moment w. pₖ^{(w)} represents a second pose or a fourth pose of a k-th second robot at the moment w. d₍ₛ_{ₖ}_{-w,w)} represents a first distance or a second distance between the first robot and the k-th second robot at the moment w. It should be understood that the number m of the second robots refers to the number of the second robots that the first robot is allowed to obtain n poses (i.e., the second poses or the fourth poses). For example, at the first moment, assuming that the first robot has obtained one second pose and (n−1) fourth poses of the robot B, one second pose and (n−1) fourth poses of the robot C, and one second pose and (n−1) fourth poses of the robot D, then the number m of the second robots is 3.

In one embodiment, after obtaining the first initial pose and the second initial poses of the first robot, the first robot determines the pose deviation of the first robot based on the first initial pose, the first pose, the second initial poses and the third poses. Optionally, the first robot obtains the pose deviation of the first robot by minimizing a specific optimization objective (such as a second optimization objective). The second optimization objective is represented by:

$$min {\sum }_{w = 1}^{n} {( Δ \hat{R} {p}_{( S - w )} - Δ \hat{φ} - {\hat{p}}_{( S - w )} )}^{2} .$$

n is the number of the second moments where the second poses or the fourth poses are obtained. Δ\hat{R} represents the rotation deviation. \hat{p}_{(S-w)} represents the translation deviation. p_{(S-w)} is the first pose or a third pose of the first robot at a moment w. p_{(S-w)} is the first initial pose or a second initial pose of the first robot at the moment w.

In another optional implementation, after obtaining the historical distance (i.e., the second distances between the first robot and the second robots at the second moments), the historical poses (i.e., the fourth poses of the second robots at the second moment), and displacements (i.e., the first displacement of the first robot at the first moment and the second displacements of the first robot at the second moments), the first robot directly obtains the pose deviation of the first robot by minimizing a specific optimization objective (e.g., a third optimization objective).

Optionally, the step of determining the pose deviation of the first robot according to the first pose, the second poses, the third poses, the fourth poses, the first distances, the second distances, the first displacement, and the second displacements comprises obtaining the pose deviation of the first robot by minimizing a third optimization objective. The third optimization objective is:

$$min {\sum }_{k = 1}^{m} {\sum }_{w = 1}^{n} {( {‖ \hat{R} {p}_{( S - w )} - Δ \hat{φ} - \hat{R} {φ}_{( s - w )} - {p}_{k} ( w ) ‖}^{2} - {d}_{( {S}_{k} - w , w )}^{2} )}^{2} .$$

m is the number of the second robots, n is the number of the second moments where the second poses or the fourth poses are obtained. \hat{R} is a rotation matrix. Δ\hat{φ} is the translation deviation. p_{(S-w)} represents the first pose or a third pose of the first robot at the moment w. φ_{(S-w)} represents the first displacement or a second displacement of the first robot at the moment w. pₖ^{(w)} represents a second pose or a fourth pose of a k-th second robot at the moment w. d₍ₛ_{ₖ}_{-w,w)} represents a first distance or a second distance between the first robot and the k-th second robot at the moment w. It should be understood that the number m of the second robots refers to the number of the second robots each having n poses that are obtained by the first robot.

It should be understood that the rotation matrix \hat{R} is related to a pitch angle, a roll angle, and a yaw angle of the first robot. The embodiment of the present disclosure only considers the yaw angle. Therefore, when optimizing the pose deviation, the pitch angle and the roll angle in the rotation matrix are set to 0 respectively, thereby optimizing the rotation matrix to obtain the rotation deviation (Δyaw) and the translation deviation of the first robot.

In one embodiment, when there are only two robots in the communication network, that is, the first robot only obtains the poses of the second robot, sufficient historical data (e.g., historical distances between the first and second robot, historical poses of the second robot, and second displacements of the first robot) is obtained by initializing the movement of the two robots (e.g., the first robot and/or the second robot), thereby accurately determining the pose deviation of the first robot based on the historical data.

In some embodiments, after obtaining the rotation deviation and translation deviation of the first robot, to ensure the stability of the target pose of the first robot in the multi-robot system, low-pass filtering is applied to the rotation deviation and translation deviation to reduce an influence of high-time interval noise and drift, which further reduces the impact of UWB signal interruptions caused by occlusion or excessively large ranging ranges, thereby improving the robustness of positioning. For instance, methods such as sliding window or Kalman filtering may be applied to filter the rotation deviation and translation deviation

The step S103 comprises optimizing the first pose, by the first robot, according to the pose deviation to obtain a target pose of the first robot.

In this embodiment, after determining the pose deviation of the first robot, the first robot optimizes the first pose based on the pose deviation to obtain the target pose in the global coordinate system, thereby improving the accuracy of the positioning. The pose optimization involves compensating for the pose deviation to the first pose in the local coordinate system of the first robot.

For example, the first robot is able to compensate for the pose deviation to the first pose to obtain the target pose (i.e., the pose in the global coordinate system at the first moment). Alternatively, the first robot compensates for the pose deviation to subsequent pose to obtain the local coordinate system of the first robot.

In some embodiments, after optimizing the first pose of the first robot to obtain the target pose in the global coordinate system, that is, after obtaining the target pose of the first robot, the first robot writes the target pose into the UWB module thereof and broadcasts the target pose to the second robots through the UWB module thereof. Therefore, the second robots are allowed to obtain the target pose of the first robot based on the information broadcast by the UWB module of the first robot, so as to realize the sharing and optimization of the target pose. In this way, each of the second robots is enabled to accurately determine a corresponding pose deviation based on the target pose of the first robot in the global coordinate system and optimize the second pose thereof, thereby improving the accuracy and stability of cooperative positioning and enabling each of the robots to provide stable pose information in the global coordinate system.

It should be noted that each of the robots in the multi-robot system is able to continuously optimize its pose deviation in the global coordinate system based on the obtained target poses of other robots and the distances between the robot and the other robots, thereby optimizing the pose in the global coordinate system and improving positioning accuracy. The cooperative positioning method of the multi-robot system of the present disclosure is not affected by the increase or decrease in the number of the robots, is able to improve the positioning accuracy and stability of the multi-robot system, and is applicable to dynamically changing multi-robot systems.

The collaborative positioning method provided in the embodiments of the present disclosure is further illustrated below with reference to the above description.

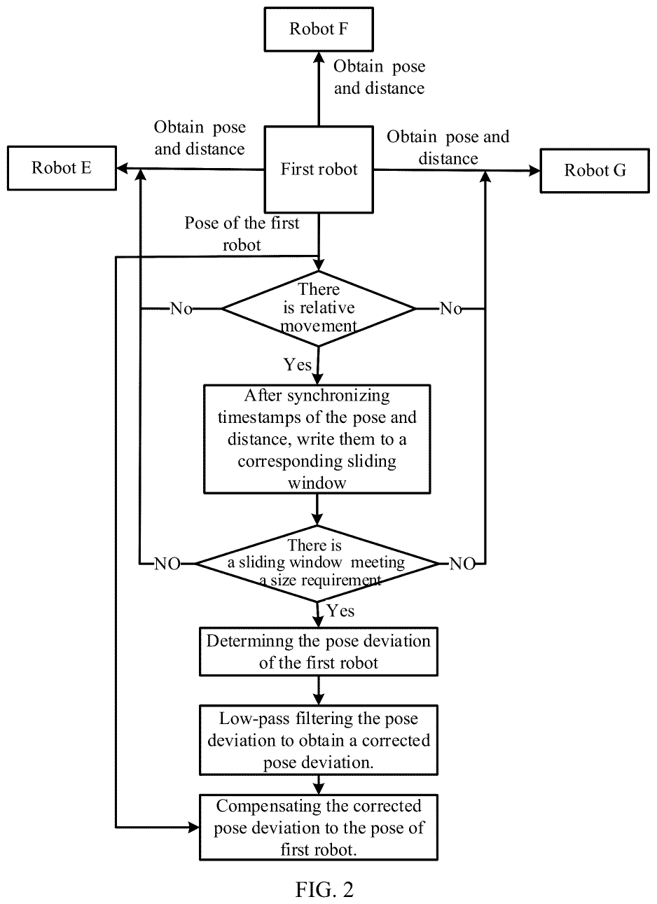

FIG. 2 is another flow chart of the cooperative positioning method according to one embodiment of the present disclosure.

As shown in FIG. 2, at a certain moment w1, the first robot is able to obtain a pose of the first robot (i.e., the first pose) and poses of other robots (e.g., robots E, F, and G), as well as distances between the first robot and the other robots.

For the robot E, the first robot is able to determine whether there is relative movement between the first robot and the robot E at the moment w1 based on the pose of the first robot and a pose of the robot E. When it is determined that there is relative movement between the first robot and the robot E at the moment w1, the first robot synchronizes timestamps of the pose of the robot E at the moment w1 and the distance between the first robot and the robot E, and then writes the pose of the robot E at the moment w1 and the distance between the first robot and the robot E into a sliding window corresponding to robot E in a database of the first robot.

For the robot F, the first robot is able to determine whether there is relative movement between the first robot and the robot F at the moment w1 based on the pose of the first robot and the pose of the robot F. When it is determined that there is relative movement between the first robot and the robot F at the moment w1, the first robot synchronizes timestamps of the pose of the robot F at the moment w1 and the distance between the first robot and the robot F, and then writes the pose of the robot F at the moment w1 and the distance between the first robot and the robot F into a sliding window corresponding to the robot F in the database of the first robot.

For the robot G, the first robot is able to determine whether there is relative movement between the first robot and the robot G at the moment w1 based on the pose of the first robot and the pose of the robot G. When there is relative movement between the first robot and the robot G at the moment w1, the first robot synchronizes timestamps of the pose of the robot G at the moment w1 and the distance between the first robot and the robot G, then writes the pose of the robot G at the moment w1 and the distance between the first robot and the robot G into a sliding window corresponding to the robot G in the database of the first robot.

After writing the data at the moment w1, the first robot determines whether a size of any one of the sliding windows meets a size requirement.

When it is determined that at least one of the sliding windows meets the size requirement, the first robot determines the pose deviation based on the data in the at least one of the sliding windows that meets the size requirement (i.e., the poses and distances of the historical moments within the at least one of the sliding windows that meets the size requirement).

After determining the pose deviation of the first robot, the first robot performs low-pass filtering on the pose deviation to obtain a corrected pose deviation. The corrected pose deviation is then compensated to the pose of the first robot at the moment w1, thus obtaining the target pose of the first robot in the global coordinate system.

When it is determined that there is no relative movement between the first robot and one of the robots (ie, a third robot), the first robot may not write a pose of the third robot and a distance between the first robot and the third robot at the moment w1 into a sliding window, corresponding to the third robot, of the first robot. Instead, at the moment w2, the first robot re-obtains the pose of the first robot and the poses of the second robots, as well as the distances between the first robot and the second robots, at the predetermined time interval.

When it is determined that the sizes of all sliding windows do not meet the size requirement, after the predetermined time internal (such as at the moment w2), the first robot re-obtains the pose of the first robot and the poses of other robots, as well as the distance between the first robot and the other robots.

After obtaining the poses of the first robot at the moment w2 and the poses of the other robots at the moment w2, as well as the distances between the first robot and the other robots at the moment w2, the first robot re-determines whether to optimize the pose deviation based on the poses of the other robots at the moment w2 and the distance between the first robot and the other robots at the moment w2, etc. Specific details of how the first robot determines whether to optimize the pose deviation based on the poses of the other robots at the moment w2 and the distance between the first robot and the other robots at the moment w2 are similar to those of how the first robot determines whether to optimize the pose deviation based on the poses of the other robots at the moment w1 and the distance between the first robot and the other robots at the moment w1, which are not repeatedly described herein.

It should be noted that, after determining the pose deviation of the first robot based on the poses of the other robots and the distances between the first robot and the other second robots at a certain moment, the first robot may continue to obtain the pose of the first robot and the poses of the other robots, as well as the distances therebetween at the predetermined time interval. Based on obtained poses and obtained distances, the first robot is able to determine whether to prioritize the pose deviation of the first robot. That is, in the embodiment, during the movement of the first robot, the first robot is able to continuously optimize the pose deviation. Based on the optimized pose deviation, the first robot is able to continuously optimize the target pose in the global coordinate system, thereby reducing accumulated positioning errors of the first robot and improving the positioning accuracy and stability.

It should be understood that the sequence number of each of the steps in the above embodiments does not imply the order of execution. The execution order of each of the steps should be determined by a function and internal logic thereof, and should not constitute any limitation on the implementation process of the embodiments of the present disclosure.

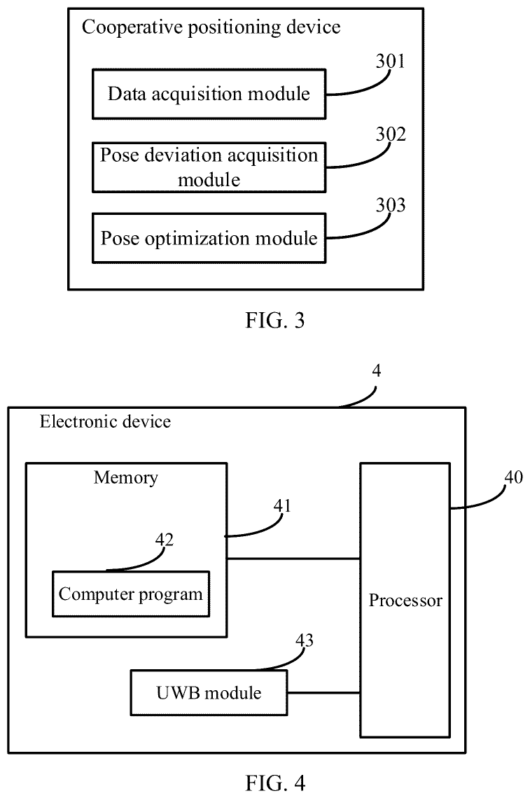

Corresponding to the cooperative positioning method described in the above embodiments, FIG. 3 is a block diagram of a cooperative positioning device according to one embodiment of the present disclosure. For ease of explanation, only parts related to the embodiments of the present disclosure are shown. The cooperative positioning device is applied to a first electronic device.

As shown in FIG. 3, the cooperative positioning device comprises a data acquisition module 301, a pose deviation acquisition module 302, and a pose optimization module 303.

The data acquisition module 301 is configured to obtain a first pose, second poses, and first distances. The first pose is a pose of the first electronic device in a local coordinate system of the first electronic device at a first moment. The second poses are poses of second electronic devices at the first moment. Each of the first distances is a distance between the first electronic device and a corresponding second electronic device at the first moment. The pose deviation acquisition module 302 is configured to determine a pose deviation of the first electronic device according to the first pose, the second poses, and the first distances. The pose optimization module 303 is configured to optimize the first pose according to the pose deviation to obtain a target pose of the first electronic device.

In some embodiments, the pose deviation acquisition module 302 is specifically configured to: determine a first initial pose of the first electronic device according to the second poses and the first distances, and determine the pose deviation of the first electronic device according to the first initial pose and the first pose.

In other embodiments, the data acquisition module 301 is configured to obtain third poses, fourth poses, second distances, a first displacement, and second displacements. The third poses are poses of the first electronic device in the local coordinate system of the first electronic device at second moments. The fourth poses are poses of the second electronic devices at the second moments. The second distances are distances between the first electronic device and the second electronic devices at the second moments. The first displacement is a displacement of the first electronic device at the first moment. The second displacements are displacements of the first electronic device at the second moments. The second moments are earlier than the first moment.

The pose deviation acquisition module 302 is specifically configured to determine the pose deviation of the first electronic device according to the first pose, the second poses, the third poses, the fourth poses, the first distances, the second distances, the first displacement, and the second displacements.

In one embodiment, the pose deviation acquisition module 302 is configured to determine the first initial pose and a second initial poses of the first electronic device according to the second poses, the fourth poses, the first distances, the second distances, the first displacement, and the second displacements; and the pose deviation acquisition module 302 is further configured to determine the pose deviation of the first electronic device according to the first initial pose, the second initial poses, the first pose, and the third poses.

Optionally, the pose deviation acquisition module 302 is configured to obtain the first initial pose and the second initial poses of the first electronic device by minimizing a first optimization objective.

The first optimization objective is represented by:

$$min {\sum }_{k = 1}^{m} {\sum }_{w = 1}^{n} {( {‖ {\hat{p}}_{( S - w )} - {φ}_{( S - w )} - {p}_{k} ( w ) ‖}^{2} - {d}_{( {S}_{k} - w , w )}^{2} )}^{2} .$$

m is the number of the second electronic devices. n is the number of the second moments where the second poses or the fourth poses are obtained. \hat{p}_{(S-w)} represents the first initial pose or a second initial pose of the first electronic device at a moment w. φ_{(S-w)} represents the first displacement or a second displacement of the first electronic device at the moment w. pₖ^{(w)} represents a second pose or a fourth pose of a k-th second electronic device at the moment w. d₍ₛ_{ₖ}_{-w,w)} represents a first distance or a second distance between the first electronic device and the k-th second electronic device at the moment w.

Optionally, the pose deviation acquisition module 302 is configured to obtain the pose deviation of the first electronic device by minimizing a second optimization objective. The pose deviation of the first electronic device comprises a rotation deviation and a translation deviation.

The second optimization objective is:

$$min {\sum }_{w = 1}^{n} {( Δ \hat{R} {p}_{( S - w )} - Δ \hat{φ} - {\hat{p}}_{( S - w )} )}^{2} .$$

n is the number of the second moments where the second poses or the fourth poses are obtained. Δ\hat{R} represents the rotation deviation. \hat{p}_{(S-w)} represents the translation deviation. p_{(s-w)} is the first pose or a third pose of the first electronic device at a moment w. \hat{p}_{(S-w)} is the first initial pose or a second initial pose of the first electronic device at the moment w.

Optionally, the pose deviation acquisition module 302 is configured to: obtain the pose deviation of the first electronic device by minimizing a third optimization objective. The pose deviation of the first electronic device comprises a rotation deviation and a translation deviation. The third optimization objective is:

$$min {\sum }_{k = 1}^{m} {\sum }_{w = 1}^{n} {( {‖ \hat{R} {p}_{( S - w )} - Δ \hat{φ} - \hat{R} {φ}_{( s - w )} - {p}_{k} ( w ) ‖}^{2} - {d}_{( {S}_{k} - w , w )}^{2} )}^{2} .$$

m is the number of the second electronic devices, n is the number of the second moments where the second poses or the fourth poses are obtained. \hat{R} is a rotation matrix. Δ\hat{φ} is the translation deviation. p_{(S-w)} represents the first pose or a third pose of the first electronic device at a moment w. φ_{(S-w)} represents the first displacement or a second displacement of the first electronic device at the moment w. pₖ^{(w)} represents a second pose or a fourth pose of a k-th second electronic device at the moment w. d₍ₛ_{ₖ}_{-w,w)}represents a first distance or a second distance between the first electronic device and the k-th second electronic device at the moment w.

In some embodiments, the first electronic device comprises a first UWB module. The second electronic devices comprise second UWB modules. The data acquisition module 301 is configured to obtain the second poses broadcast by the second UWB modules through the first UWB module and obtain the first distances through the first UWB module.

It should be noted that content such as information interaction and execution processes between the above-mentioned devices/units is based on the same concept as the embodiments of the method of the present disclosure, and for specific functions and technical effects, reference may be made to the embodiments of the method, and details are not described herein again.

It is clearly understood by those skilled in the art that, for the purpose of convenient and brief description, only the foregoing functional units and division of the modules are used for illustration. In practical applications, the foregoing functions may be allocated to different functional units/modules according to needs, so that the internal structure of the device is divided into different functional units or modules to complete all or some of the functions described above. Functional units and modules in the embodiments may be integrated into one processing unit, or each of the units may exist alone physically, or two or more units are integrated into one unit. The integrated unit may be implemented in a form of hardware, or may be implemented in a form of a software functional unit. In addition, specific names of the functional units and modules are merely for ease of distinguishing the functional units and modules from each other, and are not intended to limit the protection scope of the present disclosure. For a specific working process of the functional units and modules in the foregoing system, reference may be made to a corresponding process in the foregoing embodiments of the method, and details are not described herein again.

FIG. 4 is a block diagram of an electronic device according to one embodiment of the present disclosure. As shown in FIG. 4, the electronic device 4 comprises a UWB module 43, a memory 41, at least one processor 40 (only one processor 40 is shown in FIG. 4), and a computer program 42 stored in the memory 41. The computer program 42 is executable on the at least one processor 40. The UWB module 43 is configured to obtain pose information and distance information. When the at least one processor 40 executes the computer program 42, the electronic device implements the cooperative positioning method described above.

The electronic device 4 may be a robot, an unmanned vehicle, a drone, or an unmanned boat, or other mobile electronic device capable of positioning. The electronic device 4 may comprise, but is not limited to, the at least one processor 40 and the memory 41. Those skilled in the art may understand that FIG. 4 is merely an example of the electronic device 4 and does not constitute a limitation on the electronic device 4. The electronic device 4 may comprise more or fewer components than illustrated, or combine certain components, or different components, such as input/output devices, network access devices, etc.

The at least one processor 40 may be a central processing unit (CPU), or the at least one processor 40 may be a general-purpose processor, a digital signal processor (DSP), an application-specific integrated circuits (ASIC), a field-programmable gate arrays (FPGA), a programmable logic device, a discrete gate a transistor logic device, a discrete hardware component, etc. The general-purpose processor may be a microprocessor or any conventional processor.

The memory 41, in some embodiments, may be an internal storage unit of the electronic device 4, such as a hard disk or RAM. In some embodiments, the memory 41 may also be an external storage device of the electronic device 4, such as a plug-in hard drive, a smart media card (SMC), a secure digital (SD) card, a flash card, etc., equipped on the electronic device 4. Furthermore, the memory 41 may comprise both the internal storage unit and the external storage device of the electronic device 4. The memory 41 is configured to store the operating system, applications, bootloader, data, and other programs, such as program codes of the computer program. The memory 41 is further configured to temporarily store data that has been output or to be output.

The present disclosure provides a computer-readable storage medium. The computer-readable storage medium comprises a computer program stored thereon. When executed by the electronic device, the computer program causes the electronic device to perform the steps of the cooperative positioning method described above.

The present disclosure provides a computer program product. The computer program product comprises a computer program. When the computer program is executed by an electronic device, the computer program causes the electronic device to implement the cooperative positioning method described above.

When an integrated unit is implemented as a software functional unit and sold or used as an independent product, the integrated unit may be stored on a computer-readable storage medium. Based on this understanding, all or part of the processes in the methods of the above embodiments may be implemented by a computer program instructing related hardware. The computer program may be stored on a computer-readable storage medium, and when executed by the at least one processor, the computer program implements the steps of the method of the embodiments described above. The computer program comprises program codes, which are in a form of source codes, object codes, executable files, or certain intermediate forms. The computer-readable storage medium comprises at least: any entity or device capable of carrying the program codes to a device/electronic device, a recording medium, a computer memory, a read-only memory (ROM), a random access memory (RAM), an electrical carrier signal, a telecommunication signal, and a software distribution medium. Examples comprise USB flash drives, portable hard drives, magnetic disks, or optical disks. In some jurisdictions, according to legislation and patent practice, the computer-readable storage medium cannot be electrical carrier signals or telecommunication signals.

In the above-mentioned embodiments, descriptions of each embodiment have their own emphasis. For parts that are not described in detail or recorded in one embodiment, reference may be made to related descriptions of other embodiments.

Those of ordinary skill in the art can realize that units and algorithm steps of each example described in conjunction with the embodiments disclosed herein can be implemented in electronic hardware, or a combination of computer software and electronic hardware.

Whether these functions are performed in hardware or software depends on the specific application and design constraints of the technical solutions. Those of ordinary skill in the art may implement the described functionality using different methods for each particular application, and such implementations should not be considered beyond the scope of the present disclosure.

In the embodiments of the present disclosure, it should be understood that any disclosed device, electronic device and method are allowed to be implemented in other ways. For example, the device or the electronic device in the embodiments described above is only illustrative. For another example, a division of units is only a logical function division. In actual implementation, there may be other division methods. For another example, multiple units or components may be combined or integrated into another system. Alternatively, some features may be omitted or not implemented. In addition, features shown or discussed may be coupled, directly coupled, or communicated with each other through interfaces. Alternatively, the devices or the units may be direct coupled or communicated in electrical, mechanical or other forms.

The units described as separate parts may or may not be physically separate, and parts of the units may or may not be physical units. That is, the parts of the units may be located in one position, or may be distributed on a plurality of network units. Some or all of the units can be selected to achieve the purpose of this embodiment according to actual needs.

The above-mentioned embodiments are only used to illustrate technical solutions of the present disclosure, but not to limit the present disclosure. Although the present disclosure has been described in detail with reference to the foregoing embodiments, It should be understood that those of ordinary skill in the art are still able to modify the technical solutions described in the foregoing embodiments, or equivalently replace some of the technical features in the foregoing embodiments; and these modifications or replacements do not make the essence of the corresponding technical solutions deviate from the spirit and scope of the technical solutions of the embodiment of the present disclosure, which shall be comprised in the protection scope of the present disclosure.

What is claimed is:

1. A cooperative positioning method, applied to a first electronic device, comprising steps:
obtaining a first pose, second poses, and first distances, wherein the first pose is a pose of the first electronic device in a local coordinate system of the first electronic device at a first moment, the second poses are poses of second electronic devices at the first moment, and each of the first distances is a distance between the first electronic device and a corresponding second electronic device at the first moment;
determining a pose deviation of the first electronic device according to the first pose, the second poses, and the first distances; and
optimizing the first pose according to the pose deviation to obtain a target pose of the first electronic device;
wherein the step of determining the pose deviation of the first electronic device according to the first pose, the second poses, and the first distances comprises steps:
determining a first initial pose of the first electronic device according to the second poses and the first distances; and
determining, the pose deviation of the first electronic device according to the first initial pose and the first pose;
wherein the cooperative positioning method further comprises a step:
obtaining third poses, fourth poses, second distances, a first displacement, and second displacements;
wherein the third poses are poses of the first electronic device in the local coordinate system of the first electronic device at second moments, the fourth poses are poses of the second electronic devices at the second moments, the second distances are distances between the first electronic device and the second electronic devices at the second moments, the first displacement is a displacement of the first electronic device at the first moment, the second displacements are displacements of the first electronic device at the second moments, and the second moments are earlier than the first moment;
wherein the step of determining the pose deviation of the first electronic device according to the first pose, the second poses, and the first distances comprises steps:
determining the first initial pose and second initial poses of the first electronic device according to the second poses, the fourth poses, the first distances, the second distances, the first displacement, and the second displacements; and
determining the pose deviation of the first electronic device according to the first initial pose, the second initial poses, the first pose, and the third poses.

2. The cooperative positioning method according to claim 1, wherein the step of determining the first initial pose and the second initial poses of the first electronic device according to the second poses, the fourth poses, the first distances, the second distances, the first displacement, and the second displacements comprises:
obtaining the first initial pose and the second initial poses of the first electronic device by minimizing a first optimization objective;
wherein the first optimization objective is represented by:
$$min {\sum }_{k = 1}^{m} {\sum }_{w = 1}^{n} {( {‖ {\hat{p}}_{( S - w )} - {φ}_{( S - w )} - {p}_{k} ( w ) ‖}^{2} - {d}_{( {S}_{k} - w , w )}^{2} )}^{2} ;$$
where m is the number of the second electronic devices, n is the number of the second moments where the second poses or the fourth poses are obtained, \hat{p}_{(S-w)} represents the first initial pose or a second initial pose of the first electronic device at a moment w, φ_{(s-w)} represents the first displacement or a second displacement of the first electronic device at the moment w, pₖ^{(w)} represents a second pose or a fourth pose of a k-th second electronic device at the moment w, and d₍ₛ_{ₖ}_{-w,w)} represents a first distance or a second distance between the first electronic device and the k-th second electronic device at the moment w.

3. The cooperative positioning method according to claim 1, wherein the step of determining the pose deviation of the first electronic device according to the first initial pose, the second initial poses, the first pose, and the third poses comprises:
obtaining the pose deviation of the first electronic device by minimizing a second optimization objective;
wherein the pose deviation of the first electronic device comprises a rotation deviation and a translation deviation, and the second optimization objective is:
$$min {\sum }_{w = 1}^{n} {( Δ \hat{R} {p}_{( S - w )} - Δ \hat{φ} - {\hat{p}}_{( S - w )} )}^{2} ;$$
n is the number of the second moments where the second poses or the fourth poses are obtained, Δ\hat{R} represents the rotation deviation, \hat{p}_{(S-w)} represents the translation deviation, p_{(s-w)} is the first pose or a third pose of the first electronic device at a moment w, and \hat{p}_{(S-w)} is the first initial pose or a second initial pose of the first electronic device at the moment w.

4. The cooperative positioning method according to claim 1, wherein the step of determining the pose deviation of the first electronic device according to the first initial pose, the second initial poses, the first pose, and the third poses comprises:
obtaining the pose deviation of the first electronic device by minimizing a third optimization objective;
wherein the pose deviation of the first electronic device comprises a rotation deviation and a translation deviation, and the third optimization objective is:
$$min {\sum }_{k = 1}^{m} {\sum }_{w = 1}^{n} {( {‖ \hat{R} {p}_{( S - w )} - Δ \hat{φ} - \hat{R} {φ}_{( s - w )} - {p}_{k} ( w ) ‖}^{2} - {d}_{( {S}_{k} - w , w )}^{2} )}^{2} ;$$
where m is the number of the second electronic devices, n is the number of the second moments where the second poses or the fourth poses are obtained, \hat{R} is a rotation matrix, Δ\hat{φ} is the translation deviation, p_{(s-w)} represents the first pose or a third pose of the first electronic device at a moment w, φ_{(S-w)} represents the first displacement or a second displacement of the first electronic device at the moment w, pₖ^{(w)} represents a second pose or a fourth pose of a k-th second electronic device at the moment w, and d₍ₛ_{ₖ}_{-w,w)} represents a first distance or a second distance between the first electronic device and the k-th second electronic device at the moment w.

5. The cooperative positioning method according to claim 1, wherein the first electronic device comprises a first ultra-wideband (UWB) module, and the second electronic devices comprise second UWB modules; wherein the step of obtaining the first pose, the second poses, and the first distances comprises steps:
obtaining the second poses broadcast by the second UWB modules through the first UWB module; and
obtaining the first distances through the first UWB module.

6. An electronic device, comprising:
a UWB module;
a memory;
a processor; and
a computer program stored in the memory and executable on the processor;
wherein the UWB module is configured to obtain pose information and distance information, and when the processor executes the computer program, the electronic device implements the cooperative positioning method according to claim 1.

7. A computer program product, comprising:
a computer program;
wherein when the computer program is executed by an electronic device, the computer program causes the electronic device to implement the cooperative positioning method according to claim 1.
